(19) United States
(12) Patent Application Publication
(10) Pub. No.: US 2025/0076477 A1
(43) Pub. Date: Mar. 6, 2025

(54) CALIBRATION APPARATUS AND METHOD OF CAMERA-BASED LASER RANGE FINDER

(71) Applicant: MCNEX CO., LTD., Incheon (KR)

(72) Inventors: Young Bong PARK, Seoul (KR); Seung Jun RO, Goyang-si (KR); Dae Ki KIM, Incheon (KR); Dong Jin KIM, Namyangju-si (KR); Il Jun HWANG, Incheon (KR); Won Jong LEE, Incheon (KR); Yun Su HAN, Incheon (KR); Jin Su LEE, Incheon (KR)

(73) Assignee: MCNEX CO., LTD., Incheon (KR)

(21) Appl. No.: 18/813,092

(22) Filed: Aug. 23, 2024

(30) Foreign Application Priority Data
Aug. 30, 2023 (KR) 10-2023-0114468

(51) Int. Cl. G01S 7/497; G01S 17/42; G01S 17/86; G06T 7/80

(52) U.S. Cl. CPC G01S 7/4972; G01S 17/42; G01S 17/86; G06T 7/80; G06T 2207/10028; G06T 2207/20132

(57) ABSTRACT

The present invention description relates to a technology for calibrating an assembly error in a laser range finder, and more specifically, to a software technology for calibrating an assembly error between a laser component and an optical component.

According to one aspect of the proposed invention, in order to calibrate a difference between a position of a center of a captured image and a position of a laser point due to an assembly error, the laser point is positioned at a center of a preview screen image output on a display of a laser range finder.

### CROSS-REFERENCE TO RELATED APPLICATION(S)

This application claims priority from Korean Patent Application No. 10-2023-0114468, filed on Aug. 30, 2023, in the Korean Intellectual Property Office, the disclosure of which is incorporated herein by reference in its entirety.

### BACKGROUND

### 1. Field

The following description relates to a technology for calibrating an assembly error in a laser range finder, and more specifically, to a software technology for calibrating an assembly error between a laser component and an optical component.

### 2. Description of Related Art

Laser range finders are used in various fields such as smartphone cameras, car cameras, golf range finders, military rifles, and the like. As illustrated in FIG. 2 of Korean Patent Publication No. 10-2023-0017701, a laser golf range finder in the related art includes a laser irradiation unit (not illustrated), a range finder body 21 in which control circuits and the like are accommodated, a laser irradiation lens 22 formed on a front of the range finder body 21 and emitting a laser toward a distance measurement target, and an eyepiece 23 formed on a rear of the range finder body 21 and displaying information such as a distance measured toward the eyes of a user 10 therein.

That is, according to the laser range finder in the related art, a path of the laser output by the laser irradiation unit passes through the inside of a lens optical system. Accordingly, in order to accurately assemble laser-related components and lens optical system components without error when a range finder is produced, only small quantities of production by skilled workers are possible. Therefore, there is a problem in that the production cost becomes very large. In addition, there is a problem that it is difficult for a user to aim a laser point at the measurement target.

Meanwhile, the applicant of the present invention has contrived a camera-based laser range finder including a camera and a display that outputs an image captured by the camera and a laser point image so that the laser point may be easily aimed at the measurement target.

When producing the camera-based laser range finder, a laser component and a camera optical system component may be assembled in a housing. However, assembly errors may occur due to differences in the two components themselves.

Due to the assembly error, as illustrated in FIG. 9, target points viewed by a laser point 212 and a camera aiming line 2811 on a preview screen 281 of a display of the camera-based laser range finder may not match.

When the laser point 212 and the camera aiming line 2811 do not match, it may be difficult or impossible to accurately aim the laser point 212 at the measurement target. Therefore, when assembly errors occur during product production, since reassembly of components or the like is necessary, problems that the production process rate is lowered and problems of rising costs may occur.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to providing a screen calibration apparatus and a screen calibration method of calibrating an assembly error between a laser component and a camera optical system component included in a laser range finder.

Further, the following description relates to providing a calibration apparatus and method of calibrating an assembly error occurring between a laser component and a camera optical system component included in a laser range finder using software.

In one general aspect, in order to calibrate a difference between a position of a center of a captured image and a position of a laser point due to an assembly error, the laser point is positioned at a center of a preview screen image output on a display of a laser range finder.

In another general aspect, using an X-axis direction calibration value and a Y-axis direction calibration value for calibrating a difference between a position of a center of a captured image and a position of a laser point due to an assembly error, a region in which the position of the laser point is a center of a preview screen of a display of a laser range finder is extracted from the captured image.

In still another general aspect, by cropping a captured image of a resolution within a camera optical system's field of view of a laser range finder, a low-resolution preview screen image is generated, and the generated image is output onto a display of the laser range finder, wherein a position of the laser point of the laser range finder which is different from a center of the captured image due to assembly error becomes a center of the low-resolution preview screen image.

In yet another general aspect, by rotating a test jig equipped with a laser range finder in a yaw direction and a pitch direction, an X-axis direction calibration value and a Y-axis direction calibration value from a position of a center of a captured image to a position of a laser point due to an assembly error are calculated.

Other features and aspects will be apparent from the following detailed description, the drawings, and the claims.

### BRIEF DESCRIPTION OF THE DRAWINGS

FIG. 1 is a block diagram illustrating a screen calibration apparatus of a laser range finder according to one embodiment.

FIG. 2 is a block diagram illustrating a configuration of a calibration value computation unit according to one embodiment.

FIG. 3 is a flowchart illustrating a screen calibration method of a laser range finder according to one embodiment.

FIG. 4 is a block diagram illustrating a screen calibration apparatus of a laser range finder according to another embodiment.

FIG. 5 is a block diagram illustrating a configuration of a display controller according to still another embodiment.

FIG. 6 is a diagram illustrating a process of calculating a calibration value for positioning a laser point at the center of a calibration chart in a captured image.

FIG. 7A is a diagram illustrating one example of a captured image in which a laser point moves in a Y direction by rotating a test jig in a pitch direction.

FIG. 7B is a diagram illustrating one example of a captured image in which the laser point moves in an X direction by rotating the test jig in a yaw direction and thus the laser point is positioned at the center of a calibration chart.

FIG. 8 is a diagram for describing a concept of cropping a captured image so that a position of a laser point is the center of a displayed image.

FIG. 9 is a diagram illustrating one example of a display screen of a laser range finder in which a laser point and a camera aiming line on a preview screen do not match due to an assembly error.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The foregoing and additional aspects are embodied through embodiments described with reference to the accompanying drawings. It is understood that various combinations of components of each embodiment are possible within one embodiment as long as there is no other mention or contradiction between the components.

### [Description of Claim 1 and Claim 6]

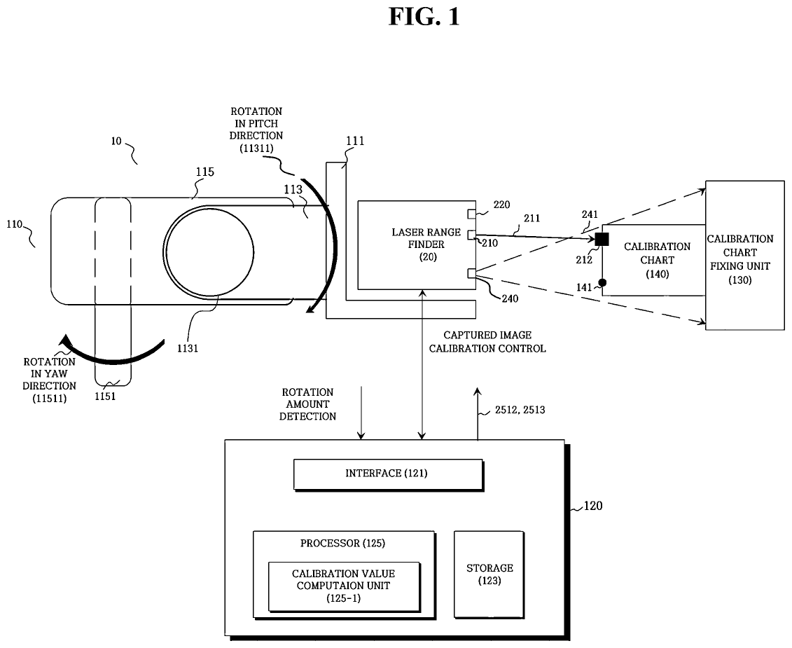

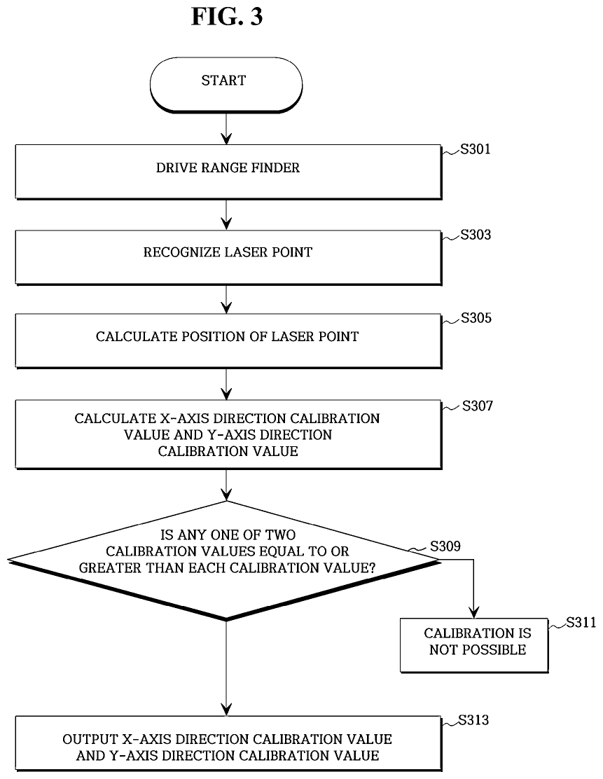

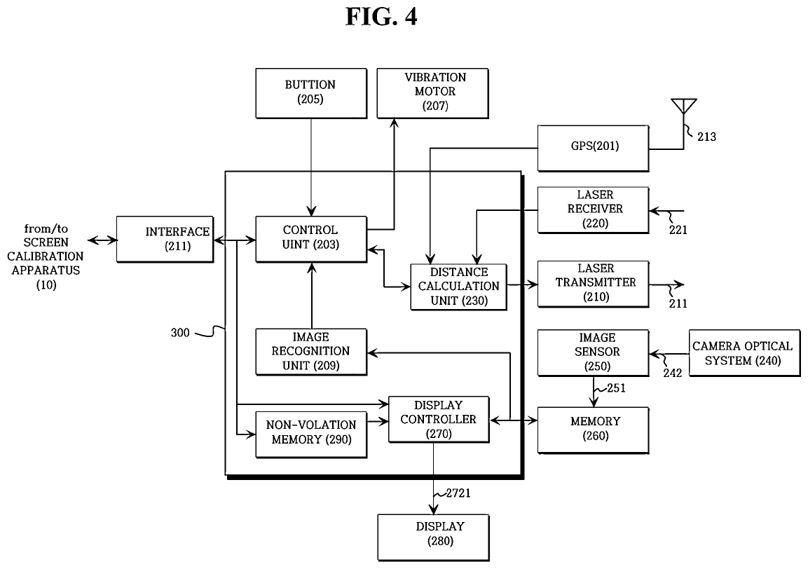

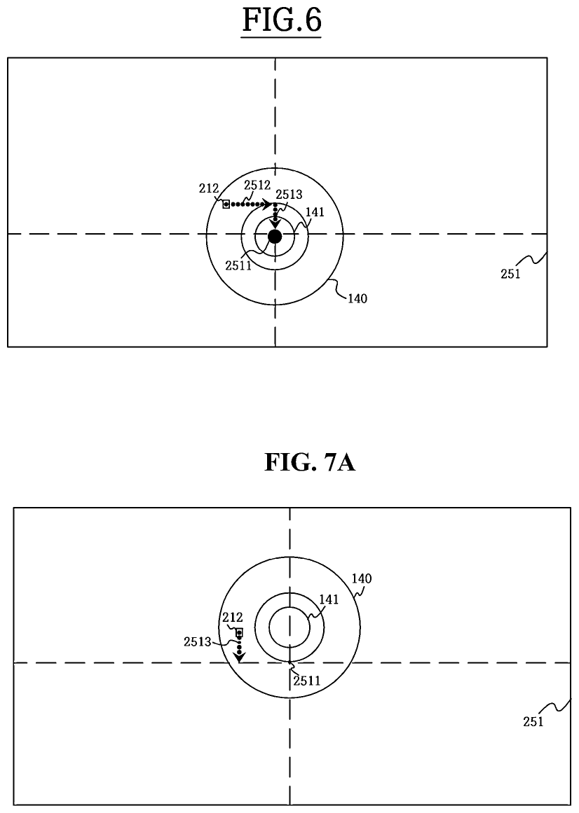

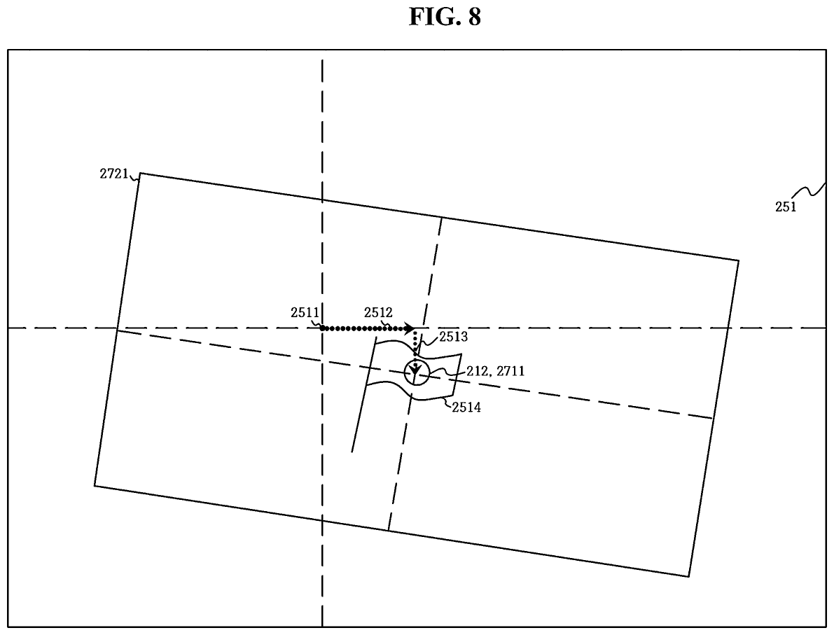

FIG. 1 is a block diagram illustrating a screen calibration apparatus of a laser range finder according to one embodiment, FIG. 3 is a flowchart illustrating a screen calibration method of a laser range finder according to one embodiment, FIG. 4 is a block diagram illustrating a screen calibration apparatus of a laser range finder according to another embodiment, FIG. 6 is a diagram illustrating a process of calculating a calibration value for positioning a laser point at the center of a calibration chart in a captured image, and FIG. 8 is a diagram for describing a concept of cropping a captured image so that a position of a laser point is the center of a displayed image.

Hereinafter, description will be given with reference to the above drawings.

As illustrated in FIG. 1, a screen calibration apparatus 10 of a laser range finder according to the present invention includes a test jig 110 equipped with a laser range finder 20 that is a device under test (DUT), a calibration chart fixing member 130 positioned at a certain distance in front of the test jig, and a calibration controller 120 including an interface 121 connected to the laser range finder 20, a storage 123 for storing a program, and a processor 125 for executing the program, and the program executed by the processor 125 includes a calibration value computation program instruction set 125-1 for providing information on a preview screen region 2721 extracted from a captured image 251 output from an image sensor 250 of the laser range finder 20 and calculating and outputting an X-axis direction calibration value 2512 and a Y-axis direction calibration value 2513 required for a laser point 212 to be positioned at a center 2711 of the preview screen 2721.

The test jig 110 is equipped with the laser range finder 20 that is a device under test (DUT). In the embodiment, the test jig 110 may include a mounting frame 111 on which the laser range finder 20 is mounted. The laser range finder 20, in which laser components 210 and 220 and a camera optical system component 240 are assembled, may be mounted on the mounting frame 111 of the test jig 110 to calibrate an assembly error between the two components. The mounting frame 111 and a calibration chart 140 may be positioned at a certain distance, and the laser range finder 20 may be mounted.

The calibration chart fixing member 130 is positioned at a certain distance in front of the test jig 110. The calibration chart fixing member 130 fixes the calibration chart 140.

The calibration controller 120 includes the interface 121 connected to the laser range finder 20, the storage 123 for storing a program, and the processor 125 for executing the program. In the embodiment, the calibration controller 120 is communicatively connected to peripheral devices such as the laser range finder 20 or the like through the interface 121 to perform data/image communication. The interface 121 may support communication standards for transmitting and receiving images and data with computer peripheral devices.

The calibration controller 120 may be implemented as a computer that executes the program stored in the storage 123 using the processor 125.

The storage 123 may be implemented in various forms such as an auxiliary storage disposed inside the computer, an external storage connected to the computer through a cable, a network storage connected through a wired/wireless network, a storage on another computer connected through a network, or a cloud storage implemented by multiple servers on a network.

The program is stored in the storage 123. The processor 125 executes the program. A block 125-1 of the processor 125 of FIG. 1 may be implemented as a computer program instruction set extracted and executed by the processor 125 from the storage 123. The computer program instruction set may be written as a single program routine, may be implemented as several scattered modules among the entire program code, or may be implemented as instruction sets scattered in one module.

According to an advantageous aspect of the present invention, the program executed by the processor 125 includes the calibration value computation program instruction set 125-1. The calibration value computation program instruction set 125-1 provides information on the preview screen region 2721 extracted from the captured image 251 output from the image sensor 250 of the laser range finder 20 and calculates and outputs the X-axis direction calibration value 2512 and the Y-axis direction calibration value 2513 required for a laser point 212 to be positioned at a center 2711 of the preview screen 2721.

The image sensor 250 of the laser range finder 20 converts the incident light 242 within a field of view 241 of the camera optical system and outputs the captured image 251. In the embodiment, the captured image 251 may have a resolution of 13.13 MP (4208×3120) pixels. As illustrated in FIG. 6, the captured image 251 may include an image of the laser point 212 and an image of the calibration chart 140. In addition, as illustrated in FIG. 8, the captured image 251 may include an image of the laser point 212 and an image of a target 2514.

According to a characteristic aspect of the present invention, the preview screen region (see 2721) is extracted from the entire region of the captured image 251. The calibration value computation program instruction set 125-1 provides information for extracting the preview screen region 2721 from the captured image 251.

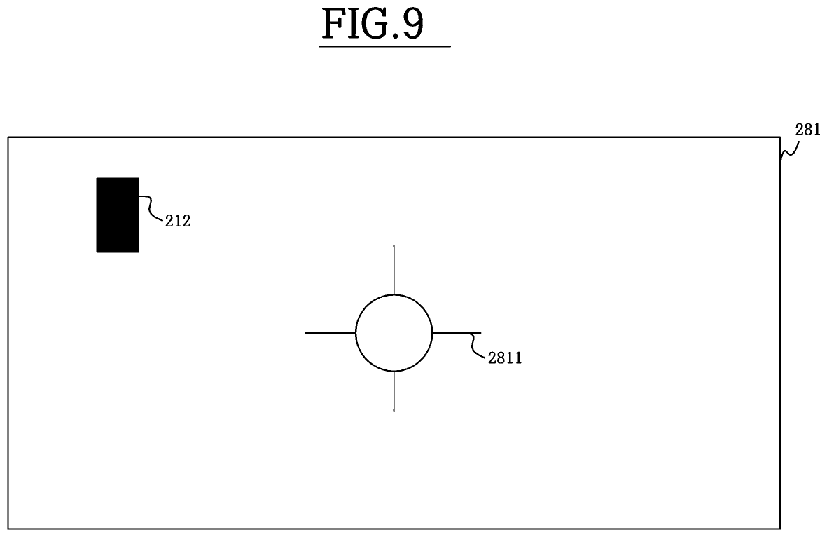

In the related art, the position of the center 2511 of the captured image 251 and the position of the center (see 2811 in FIG. 9) of at least a portion of the captured image 251, for example, a preview screen image (see 281 in FIG. 9) of 60% to 80% of the resolution of the captured image 251 are the same. In contrast, according to a characteristic aspect of the present invention, the position of the center 2711 of the preview screen image 2721 is not the same as the position of the center 2511 of the captured image 251 as in the related art, but is the same as the position of the laser point 212.

According to a characteristic aspect of the present invention, when the preview screen of the laser range finder is calibrated so that the laser point 212 matches the center of the preview screen (see 2711 in FIGS. 8 and 2811 in FIG. 9), a user may accurately aim the laser point 212 at the target 2514 even when an assembly error occurs between a laser component and a camera optical system component included in the laser range finder.

In order for the laser range finder 20 to provide the preview screen 2721 in which the laser point 212 is the center 2711 of the screen, according to a characteristic aspect of the present invention, the preview screen image 2721 is generated by extracting a region in which the position of the laser point 212 is the center 2711 from the entire region of the captured image 251. Due to the assembly error, the position of the laser point 212 on the captured image 251 is a different position 2711 rather than the position of the center 2511 of the captured image, and the calibration value computation program instruction set 125-1 calculates the X-axis direction calibration value 2512 and the Y-axis direction calibration value 2513 required for the laser point 212 to be positioned at the center 2711 of the preview screen 2721.

As described above, when the laser range finder is produced, an assembly error occurs between a laser component and a camera optical system component. Accordingly, as illustrated in FIG. 6, the position of the center 2511 of the captured image of the captured image 251 within the field of view 241 of the camera optical system and the position of the laser point 212 do not match. According to a preferred aspect of the present invention, the calibration value computation program instruction set 125-1 calculates the X-axis direction calibration value 2512 and the Y-axis direction calibration value 2513 to calibrate a difference between the position of the center 2511 of the captured image 251 and the position of the laser point 212 due to the assembly error.

Meanwhile, as illustrated in FIG. 1, a screen calibration method 10 of a laser range finder according to the present invention is a screen calibration method of the screen calibration apparatus 10 of the laser range finder 20 including the test jig 110 equipped with the laser range finder 20 that is a device under test (DUT), the calibration chart fixing unit 130 positioned at a certain distance in front of the test jig 110, and the calibration controller 120 including the interface 121 connected to the laser range finder 20, the storage 123 for storing a program, and the processor 125 for executing the program, the screen calibration method including a receiving operation of receiving the captured image 251 output from the image sensor 250 of the laser range finder 20 and a calibration value computing operation of providing information on the preview screen region 2721 extracted from the captured image 251 and calculating and outputting the X-axis direction calibration value 2512 and the Y-axis direction calibration value 2513 required for the laser point 212 to be positioned at the center 2711 of the preview screen 2721.

As described above, the calibration controller 120 is communicatively connected to peripheral devices such as the laser range finder 20 or the like through the interface 121 to perform data/image communication. The interface 121 may support communication standards for transmitting and receiving images and data with computer peripheral devices. In addition, the calibration controller 120 may be implemented as a computer that executes the program stored in the storage 123 using the processor 125. The program is stored in the storage 123. The processor 125 executes the program. The block 125-1 of the processor 125 of FIG. 1 may be implemented as a computer program instruction set extracted and executed by the processor 125 from the storage 123.

According to an advantageous aspect of the present invention, the program executed by the processor 125 includes the calibration value computation program instruction set 125-1. The calibration value computation program instruction set 125-1 may control the interface 121 to receive at least a portion of the captured image 251 output from the image sensor 250 of the laser range finder 20. That is, the captured image 251 output from the image sensor 250 may be a captured image 251 of a full resolution within a camera's field of view, or a portion of the captured image 251 of the full resolution according to the self-setting of the laser range finder 20.

Further, in the next operation, the calibration value computation program instruction set 125-1 provides information on the preview screen region 2721 extracted from the captured image 251 and calculates and outputs the X-axis direction calibration value 2512 and the Y-axis direction calibration value 2513 required for the laser point 212 to be positioned at the center of the preview screen 2721.

The image sensor 250 of the laser range finder 20 converts the incident light 242 within a field of view 241 of the camera optical system and outputs the captured image 251. In the embodiment, the captured image 251 may have a resolution of 13.13 MP (4208×3120) pixels. As illustrated in FIG. 6, the captured image 251 may include the image of the laser point 212 and the image of the calibration chart 140. In addition, as illustrated in FIG. 8, the captured image 251 may include an image of the laser point 212 and an image of a target 2514.

According to a characteristic aspect of the present invention, the preview screen region (see 2721) is extracted from the entire region of the captured image 251. The calibration value computation program instruction set 125-1 provides information for extracting the preview screen region 2721 from the captured image 251.

In the related art, the position of the center 2511 of the captured image 251 and the position of the center (see 2811 in FIG. 9) of at least a portion of the captured image 251, for example, the preview screen image (see 281 in FIG. 9) of 60% to 80% of the resolution of the captured image 251 are the same. In contrast, according to a characteristic aspect of the present invention, the position of the center 2711 of the preview screen image 2721 is not the same as the position of the center 2511 of the captured image 251 as in the related art, but is the same as the position of the laser point 212.

According to a characteristic aspect of the present invention, when the preview screen of the laser range finder is calibrated so that the laser point 212 matches the center of the preview screen (see 2711 in FIGS. 8 and 2811 in FIG. 9), a user may accurately aim the laser point 212 at the target 2514 even when an assembly error occurs between a laser component and a camera optical system component included in the laser range finder.

In order for the laser range finder 20 to provide the preview screen 2721 in which the laser point 212 is the center of the screen, according to a characteristic aspect of the present invention, the preview screen image 2721 is generated by extracting a region in which the position of the laser point 212 is the center from the entire region of the captured image 251. Due to the assembly error, the position of the laser point 212 on the captured image 251 is the different position 2711 rather than the position of the center of the captured image, and the calibration value computation program instruction set 125-1 calculates the X-axis direction calibration value 2512 and the Y-axis direction calibration value 2513 required for the laser point 212 to be positioned at the center 2711 of the preview screen 2721.

As described above, when the laser range finder is produced, an assembly error occurs between a laser component and a camera optical system component. Accordingly, as illustrated in FIG. 6, the position of the center 2511 of the captured image of the captured image 251 within the field of view 241 of the camera optical system and the position of the laser point 212 do not match. According to a preferred aspect of the present invention, the calibration value computation program instruction set 125-1 calculates the X-axis direction calibration value 2512 and the Y-axis direction calibration value 2513 to calibrate a difference between the position of the center 2511 of the captured image 251 and the position of the laser point 212 due to the assembly error.

### [Description of Claim 2 and Claim 7]

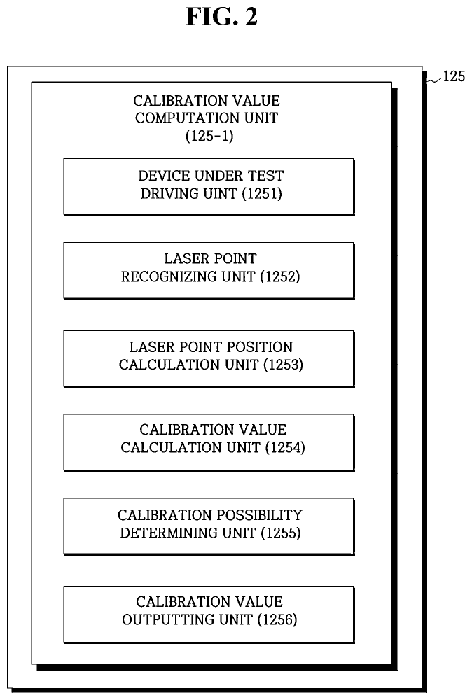

FIG. 1 is a block diagram illustrating a screen calibration apparatus of a laser range finder according to one embodiment, FIG. 2 is a block diagram illustrating a configuration of a calibration value computation unit according to one embodiment, FIG. 3 is a flowchart illustrating a screen calibration method of a laser range finder according to one embodiment, FIG. 4 is a block diagram illustrating a screen calibration apparatus of a laser range finder according to another embodiment, FIG. 6 is a diagram illustrating a process of calculating a calibration value for positioning a laser point at the center of a calibration chart in a captured image, and FIG. 8 is a diagram for describing a concept of cropping a captured image so that a position of a laser point is the center of a displayed image. Hereinafter, description will be given with reference to the above drawings.

As illustrated in FIG. 2, according to an aspect of the present invention, a calibration value computation program instruction set 125-1 may include a device under test driving program instruction set 1251 for driving a laser range finder 20, a laser point recognition program instruction set 1252 for recognizing a laser point 212 in a captured image 251 received from the laser range finder 20, a laser point position calculation program instruction set 1253 for calculating a position of the laser point 212 in the captured image 251, a calibration value calculation program instruction set 1254 for calculating an X-axis direction calibration value 2512 and a Y-axis direction calibration value 2513 required for the laser point 212 to be positioned at a center 141 of a calibration chart 140 in the captured image 251, and a calibration value output program instruction set 1256 for outputting the X-axis direction calibration value 2512 and the Y-axis direction calibration value 2513.

The device under test driving program instruction set 1251 drives the laser range finder 20. The device under test driving program instruction set 1251 drives the laser range finder 20, which is a device under test (DUT) mounted on a test jig 110 (S301). The device under test driving program instruction set 1251 may drive the laser range finder 20 by communicating with a control unit 203 through the interface 121 and an interface 211 of the laser range finder 20. In the embodiment, the interface 211 of the laser range finder 20 may be an interface for calibration.

In the embodiment, as the laser range finder 20 is driven, the laser transmitter 210 emits the laser 211. In addition, a camera optical system 240 receives incident light 242 within the field of view 241 of the camera optical system. The camera optical system 240 may include a plurality of lenses and specifies a light path and transmits the received incident light 242 to the image sensor 250. In the embodiment, the camera optical system 240 may have a zoom magnification adjustment function.

The image sensor 250 converts the incident light and outputs the captured image 251. In the embodiment, the captured image 251 may have a resolution of 13.13 MP (4208×3120) pixels. As illustrated in FIG. 6, the captured image 251 may include an image of the calibration chart 140 and an image of a laser point 212.

The laser point recognition program instruction set 1252 recognizes the laser point 212 in the captured image 251 received from the laser range finder 20 (S303).

In the embodiment, the laser point recognition program instruction set 1252 may use a known artificial intelligence technology to recognize the laser point 212. For example, the laser point recognition program instruction set 1252 may recognize the laser point 212 by repeatedly learning an image of the laser point 212 using an artificial intelligence image filter. As an artificial intelligence method of analyzing images, a convolutional neural network (CNN) method may be used. Since the technology itself for recognizing the laser point 212 in the captured image 251 using an artificial intelligence technology or the like is a technology known to those skilled in the art, a detailed description thereof will be omitted.

The laser point position calculation program instruction set 1253 calculates the position of the laser point 212 in the captured image 251 (S305). In one embodiment, the laser point position calculation program instruction set 1253 may calculate coordinates corresponding to the laser point 212 in a coordinate system of the captured image 251, a coordinate system of the image sensor 250, or a pixel coordinate system.

For example, in the pixel coordinate system of the captured image 251 in FIG. 6, assuming that a first pixel position on a left/top side is (0, 0), a last pixel position on a right/bottom side is (4280, 3120), and the position of the center 2511 of the captured image is (2104, 1560), the position of the laser point 212 may be calculated as (1744, 1720).

The calibration value calculation program instruction set 1254 calculates the X-axis direction calibration value 2512 and the Y-axis direction calibration value 2513 required for the laser point 212 to be positioned at the center 141 of the calibration chart 140 in the captured image 251 (S307).

In operation S307, the calibration value calculation program instruction set 1254 may calculate the X-axis direction calibration value 2512 and the Y-axis direction calibration value 2513 in the coordinate system of the captured image, which are required for the laser point 212 to be positioned at the center 141 of the calibration chart 140 in the captured image 251. Alternatively, the X-axis direction calibration value 2512 and the Y-axis direction calibration value 2513 of a coordinate system of a display 280 may be calculated. In one embodiment, the X-axis direction calibration value 2512 may be 360 pixels (2104 pixels-1744 pixels), and the Y-axis direction calibration value 2513 may be 160 pixels (1720 pixels-1560 pixels).

In the captured image 251 of the embodiment of FIG. 6, the position of the laser point 212 and the position of the center 2511 of the captured image do not match due to the assembly error. In the embodiment, the position of the laser point 212 and the position of the center 141 of the calibration chart 140 do not match. According to a preferred aspect of the present invention, since the calibration value calculation program instruction set 1254 of the screen calibration apparatus 10 calculates the X-axis direction calibration value 2512 and the Y-axis direction calibration value 2513 between the position of the center 2511 of the captured image and the position of the laser point 212 in the captured image 251, a display controller 270 of the laser range finder 20 may position the laser point 212 at the center (see 2711 in FIG. 8) of the preview screen image output on the display 280 of the range finder using the X-axis direction calibration value 2512 and the Y-axis direction calibration value 2513. Accordingly, even when an assembly error occurs, the laser point 212 may be accurately aimed at the target 2514.

The calibration value output program instruction set 1256 outputs the X-axis direction calibration value and the Y-axis direction calibration value. In operation S313, according to a preferred embodiment, the calibration value output program instruction set 1256 outputs the calculated X-axis direction calibration value 2512 and Y-axis direction calibration value 2513. For example, in order for a producer to later access the X-axis direction calibration value 2512 and the Y-axis direction calibration value 2513, the calibration controller 120 may store the X-axis direction calibration value 2512 and the Y-axis direction calibration value 2513 in a storage 123 or output the X-axis direction calibration value 2512 and the Y-axis direction calibration value 2513 on a monitor screen (not illustrated).

### [Description of Claim 3 and Claim 8]

FIG. 1 is a block diagram illustrating a screen calibration apparatus of a laser range finder according to one embodiment, FIG. 2 is a block diagram illustrating a configuration of a calibration value computation unit according to one embodiment, FIG. 3 is a flowchart illustrating a screen calibration method of a laser range finder according to one embodiment, and FIG. 4 is a block diagram illustrating a screen calibration apparatus of a laser range finder according to another embodiment. Hereinafter, description will be given with reference to the above drawings.

In an additional aspect of the present invention, a calibration value output program instruction set 1256 stores an X-axis direction calibration value 2512 and a Y-axis direction calibration value 2513 in a non-volatile memory 290 included in a laser range finder 20 through an interface (S313).

In operation S313, according to a preferred embodiment, the calibration value output program instruction set 1256 of a screen calibration apparatus 10 and the laser range finder 20 mounted on a mounting frame 111 of a test jig 110 may be connected through an interface 121 and an interface 211 to transmit and receive data and images. Preferably, a control unit 203 of the laser range finder 20 may execute a calibration mode by driving control of a device under test driving program instruction set 1251. In addition, the calibration value output program instruction set 1256 may store the calculated X-axis direction calibration value 2512 and Y-axis direction calibration value 2513 in the non-volatile memory 290 included in the laser range finder 20 through the interface 121 and the interface 211.

### [Description of Claim 4 and Claim 9]

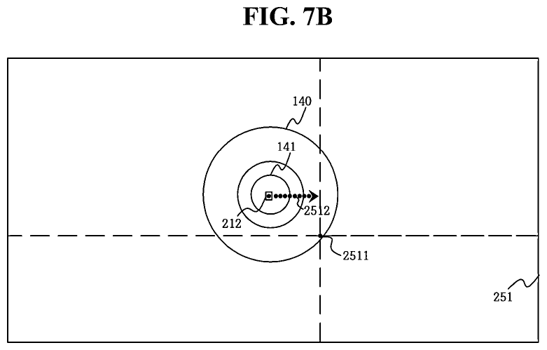

FIG. 1 is a block diagram illustrating a screen calibration apparatus of a laser range finder according to one embodiment, FIG. 2 is a block diagram illustrating a configuration of a calibration value computation unit according to one embodiment, FIG. 3 is a flowchart illustrating a screen calibration method of a laser range finder according to one embodiment, FIG. 4 is a block diagram illustrating a screen calibration apparatus of a laser range finder according to another embodiment, FIG. 6 is a diagram illustrating a process of calculating a calibration value for positioning a laser point at the center of a calibration chart in a captured image, FIG. 7A is a diagram illustrating one example of a captured image in which a laser point moves in a Y direction by rotating a test jig in a pitch direction, and FIG. 7B is a diagram illustrating one example of a captured image in which the laser point moves in an X direction by rotating the test jig in a yaw direction and thus the laser point is positioned at the center of a calibration chart. Hereinafter, description will be given with reference to the above drawings.

According to a characteristic aspect of the present invention, as a test jig 110 rotates in a yaw direction 11511 and a pitch direction 11311, a calibration value calculation program instruction set 1254 calculates an X-axis direction calibration value 2512 that is a distance moved by a laser point 212 in an X-axis direction in a captured image 251 in response to the rotation in the yaw direction 11511 and a Y-axis direction calibration value 2513 that is a distance moved by the laser point 212 in a Y-axis direction in the captured image 251 in response to the rotation in the pitch direction 11311 (S307).

In order to calibrate a difference between a position of the laser point 212 and a position of a center 2511 of the captured image in the captured image 251, the position of the laser point 212 in the captured image 251 is matched to a center 141 of a calibration chart 140 as the laser range finder 20 mounted on the test jig 110 is rotated in the yaw direction 11511 and the pitch direction 11311, so that the X-axis direction calibration value 2512 and the Y-axis direction calibration value 2513 may be calculated. Accordingly, since a calibration amount is calculated on the captured image while rotating a field of view 241 of a camera of the laser range finder 20 in the yaw direction and the pitch direction using the test jig 110 and the calibration chart 140, an accurate calibration amount may be calculated.

In the embodiment of FIG. 1, the test jig 110 may include a mounting frame 111 equipped with the laser range finder 20, a yaw direction rotation frame 115 that is rotatably coupled to a Y-axis direction rotating shaft 1151 and rotates in the yaw direction 11511, and a pitch direction rotation frame 113 whose one end is rotatably coupled to an X-axis direction rotating shaft 1131 formed at one end of the yaw direction rotation frame 115 and whose the other end is fixed to a rear surface of the mounting frame 111 and rotates in the pitch direction 11311. In the product production field, since the technology of causing the test jig 110 to rotate the assembly to be tested in the yaw direction 11511 and in the pitch direction 11311 is known, a detailed description of a hardware implementation technology of the test jig 110 itself will be omitted.

In the embodiment, a producer may manually rotate the X-axis direction rotating shaft 1131 in the pitch direction while checking the captured image 251 output on a display (not illustrated) included in a screen calibration controller 120. In addition, the producer may manually rotate the Y-axis direction rotating shaft 1151 in the yaw direction while checking the captured image 251 of the display (not illustrated) included in the screen calibration controller 120.

In the embodiment, while the field of view 241 of the camera optical system changes according to the rotation in the pitch direction as the X-axis direction rotating shaft 1131 rotates in the pitch direction, the position of the laser point 212 in the captured image 251 in FIG. 6 is moved by a calibration amount (distance) in the minus Y-axis direction to the position of the laser point 212 in the captured image 251 in FIG. 7A. The calibration value calculation program instruction set 1254 may calculate the Y-axis direction calibration value 2513 by analyzing a detection value of a decoder (not illustrated) that detects a rotation amount of the X-axis direction rotating shaft 1131 or a Y-axis distance movement distance of the laser point 212 on the captured image 251.

In the embodiment, while the field of view 241 of the camera optical system changes according to the rotation in the yaw direction as the Y-axis direction rotating shaft 1151 rotates in the yaw direction 11511, the position of the laser point 212 in the captured image 251 in FIG. 7A is moved by a calibration amount (distance) in the plus X-axis direction to the position of the laser point 212 in the captured image 251 in FIG. 7B. Alternatively, within the captured image 251, the calibration chart 140 or the center 10) 141 of the calibration chart moves in the minus X-axis direction as much as the calibration amount (distance) by which the laser point 212 moves in the plus X-axis direction. Accordingly, the position of the laser point 212 in the captured image 251 is matched to the position of the center 141 of the calibration chart.

The calibration value calculation program instruction set 1254 may calculate the X-axis direction calibration value 2512 by analyzing a detection value of a decoder (not illustrated) that detects a rotation amount of the Y-axis direction rotating shaft 1151 or an X-axis distance movement distance of the laser point 212 on the captured image 251.

### [Description of Claim 5 and Claim 10]

FIG. 1 is a block diagram illustrating a screen calibration apparatus of a laser range finder according to one embodiment, FIG. 2 is a block diagram illustrating a configuration of a calibration value computation unit according to one embodiment, FIG. 3 is a flowchart illustrating a screen calibration method of a laser range finder according to one embodiment, FIG. 4 is a block diagram illustrating a screen calibration apparatus of a laser range finder according to another embodiment, FIG. 6 is a diagram illustrating a process of calculating a calibration value for positioning a laser point at the center of a calibration chart in a captured image, and FIG. 8 is a diagram for describing a concept of cropping a captured image so that a position of a laser point is the center of a displayed image. Hereinafter, description will be given with reference to the above drawings.

Referring to FIGS. 2 and 3, a calibration possibility determination program instruction set 1255 may determine whether calibration is possible by comparing a maximum X-axis direction calibration threshold and a maximum Y-axis direction calibration threshold that are maximally calibratable in consideration of a resolution of a captured image 251 (see FIG. 8) corresponding to a field of view 241 of a camera optical system 240 of a laser range finder 20 and a minimum resolution of a preview screen image 2721 output on a display 280 of the laser range finder 20 with an X-axis direction calibration value 2512 and a Y-axis direction calibration value 2513.

In the embodiment, the determination as to whether calibration is possible is 1.5 made by comparing the maximum X-axis direction calibration threshold and the maximum Y-axis direction calibration threshold that are maximally calibratable in consideration of a full resolution (e.g., 13 MP) of the captured image 251 (see FIG. 8) corresponding to the field of view 241 of the camera optical system 240 of the laser range finder 20 and the minimum resolution (e.g., 6.5 MP) of the display image 2721 output on the display 280 of the laser range finder 20 with the X-axis direction calibration value 2512 and the Y-axis direction calibration value 2513 that are calculated by the calibration value calculation program instruction set 1254.

The larger the assembly error, that is, the closer the position of the center of the preview screen image (2721 in FIG. 8) within the captured image 251 is to an edge within a region of the captured image 251, the lower the resolution of the preview screen image 2721 output on the display 280 of the laser range finder 20 may be. Typically, the resolution of the cropped preview screen image may use 60% to 80% of the resolution of the entire captured image within the camera optical system. In the present invention, for example, up to 40% to 50% of the full resolution of the captured image may be set as the minimum resolution. Accordingly, a maximum X-axis direction calibration threshold and a maximum Y-axis direction calibration threshold corresponding to the minimum resolution (e.g., 6.5 MP) of the preview screen image 2721 may be determined. The calibration possibility determination program instruction set 1255 determines whether calibration is possible by comparing the determined maximum X-axis direction calibration threshold and maximum Y-axis direction calibration threshold that are maximally calibratable with the X-axis direction calibration value 2512 and Y-axis direction calibration value 2513 calculated in the calibration value calculating operation S307. If any one of the calculated X-axis direction calibration value 2512 and the Y-axis direction calibration value 2513 is greater than the maximum X-axis direction calibration threshold and the maximum Y-axis direction calibration threshold that are maximally calibratable, the calibration possibility determination program instruction set 1255 determines that calibration is not possible (S311).

### [Description of Claim 11]

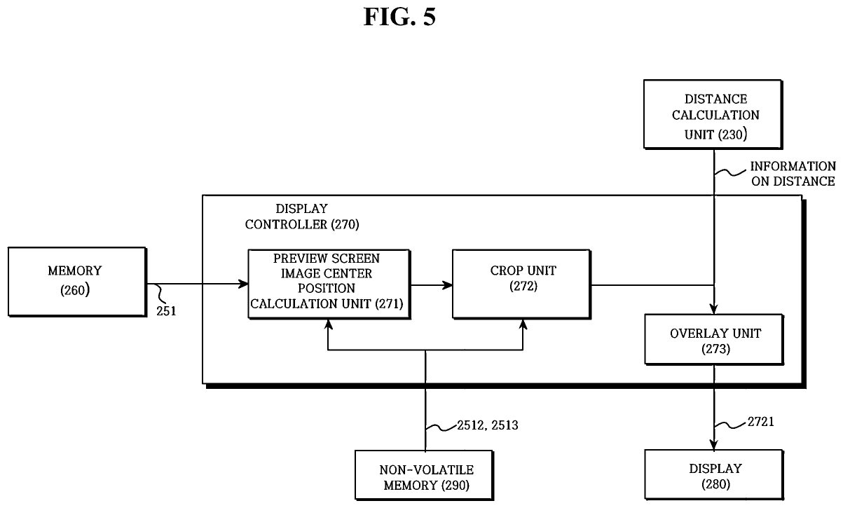

FIG. 1 is a block diagram illustrating a screen calibration apparatus of a laser range finder according to one embodiment, FIG. 2 is a block diagram illustrating a configuration of a calibration value computation unit according to one embodiment, FIG. 3 is a flowchart illustrating a screen calibration method of a laser range finder according to one embodiment, FIG. 4 is a block diagram illustrating a screen calibration apparatus of a laser range finder according to another embodiment, FIG. 5 is a block diagram illustrating a configuration of a display controller according to still another embodiment, FIG. 6 is a diagram illustrating a process of calculating a calibration value for positioning a laser point at the center of a calibration chart in a captured image, FIG. 7A is a diagram illustrating one example of a captured image in which a laser point moves in a Y direction by rotating a test jig in a pitch direction, FIG. 7B is a diagram illustrating one example of a captured image in which the laser point moves in an X direction by rotating the test jig in a yaw direction and thus the laser point is positioned at the center of a calibration chart, and FIG. 8 is a diagram for describing a concept of cropping a captured image so that a position of a laser point is the center of a displayed image. Hereinafter, description will be given with reference to the above drawings.

As illustrated in FIG. 4, in a screen calibration apparatus 10 of a laser range finder 20 according to the present invention, the laser range finder 20 includes a laser transmitter 210 that emits a laser 211, a laser receiver 220 that receives a reflected wave 221 being reflected from a target 2514 hit by the emitted laser, a camera optical system 240 that receives incident light 242 within a field of view 241 of the camera optical system 240, an image sensor 250 that converts the incident light 242 and outputs a captured image 251, a memory 260 that stores the captured image 251, a display 280 that outputs a preview screen image 2721, and a processor 300 that executes a program stored in the memory 260, where the program executed by the processor 300 includes a distance calculation program instruction set 230 for calculating a distance to the target 2514 based on the received reflected wave 221 and a display control program instruction set 270 for generating a preview screen image 2721 that displays information of the calculated distance to the target 2514 by superimposing the information on at least a portion of the captured image 251 stored in the memory 260, the laser range finder 20 further includes a non-volatile memory 290 that stores an X-axis direction calibration value 2512 and a Y-axis direction calibration value 2513 to calibrate a difference between a position of a center 2511 of the captured image 251 and a position of a laser point 212 due to an assembly error, and the display control program instruction set 270 performs control to extract a preview screen region 2721 in which a position moved from the position of the center 2511 of the captured image according to the X-axis direction calibration value 2512 and the Y-axis direction calibration value 2513 is set as a center 2711 of the preview screen region in the captured image 251 stored in the memory 260 and to output the preview screen region 2721 on the display 280.

In the embodiment, the processor 300 may be an application processor. The processor 300 may include a plurality of unit processors for each function (a core processor 203, an image signal processor 209, a display controller 270, or the like), and each unit processor may execute a corresponding program instruction set stored in the memory 260.

In the embodiment, a laser transmitter 210 emits a laser 211. The laser transmitter 210 includes a laser diode that emits the laser. A laser receiver 220 receives a reflected wave 221 reflecting from a target 2514 hit by the emitted laser 211. The laser transmitter 210 and the laser receiver 220 may be included in laser components.

A distance calculation unit 230 calculates a distance to the target 2514 based on the received reflected wave 221. The distance calculation unit 230 may calculate the distance to the target 2514 using a moving speed and transmission/reception time of the laser.

The camera optical system 240 receives the incident light 242 within the field of view 241 of the camera optical system. In the embodiment, the camera optical system 240 may include a plurality of lenses, specify a light path, and transmit the received incident light 242 to the image sensor 250. In the embodiment, the optical system 240 may have a zoom magnification adjustment function.

The image sensor 250 converts the incident light 242 and outputs the captured image 251. In the embodiment, the captured image 251 may have a resolution of 13.13 MP (4208×3120) pixels. As illustrated in FIG. 7, the captured image 251 may include an image of the target 2514. The memory 260 stores the captured image 251. The camera optical system 240 and the image sensor 250 may be included in camera components.

The display controller 270 generates the preview screen image 2721 that displays information on the distance to the target 2514 calculated by the distance calculation unit 230 by superimposing the information on at least a portion of the captured image stored in the memory 260. Furthermore, the display 280 outputs the preview screen image 2721 generated by the display controller 270.

Typically, the display controller 270 may output at least a portion of the captured image 251 of a full resolution of the field of view 241 of the camera optical system as a display image to the display 280. In addition, the display controller 270 may receive the information on the distance to the target 2514 from the distance calculation unit 230, and display the information on the distance to the target 2514 by superimposing the information on the captured image 251 including the target 2514.

According to a characteristic aspect of the present invention, the non-volatile memory 290 included in the laser range finder 20 stores an X-axis direction calibration value 2512 and a Y-axis direction calibration value 2513 in a coordinate system of the captured image for calibrating a difference between a position of a center 2511 of the captured image 251 and a position of the laser point 212 due to an assembly error.

In one embodiment, the X-axis direction calibration value 2512 and the Y-axis direction calibration value 2513 may be received from a screen calibration apparatus 10 through the interface 211. Alternatively, a producer may directly input the calibration values through a user operation interface (not illustrated) connected to the interface 211.

In the embodiment, as described above, the calculated X-axis direction calibration value 2512 and the Y-axis direction calibration value 2513 are values representing the position of the laser point 212 spaced apart from the center 2511 of the captured image as an X-axis direction distance 2512 and a Y-axis direction distance 2513 on the coordinate system of the captured image. Accordingly, the display controller 270 may position the laser point 212 at the center 2711 of the preview screen image 2721 output on the display 280 of the range finder using the X-axis direction calibration value 2512 and the Y-axis direction calibration value 2513. Accordingly, even when an assembly error occurs, the laser point 212 may be accurately aimed at the target.

In the case of a laser range finder in the related art, the center of the preview screen image corresponds to the center of the camera optical system. Accordingly, when there is an assembly error in the laser range finder, the position of the laser point and the position of the center of the preview screen image are different, making target aiming difficult or impossible. However, according to preferred aspects of the present invention, a user may aim at the target 2514 based on the position of the laser point 212 rather than the position of the center 2511 of the captured image, so that even when an assembly error occurs, the laser point 212 may be accurately aimed at the target.

An unexplained GPS 201 receives GPS signals and calculates current position information about the laser range finder 20. The distance calculation unit 230 may calculate the distance to the target using the information on the position of the target and the current position information on map data stored in the memory 260. The control unit 203 may determine and set an optical zoom magnification of the camera optical system 240 based on the calculated distance to the target.

### [Description of Claim 12]

According to an additional aspect of the present invention, the display control program instruction set 270 generates a preview screen image 2721 of a lower resolution compared to the captured image 251 by cropping the captured image 251 so that a position moved from the position of the center 2511 of the captured image according to the X-axis direction calibration value 2512 and the Y-axis direction calibration value 2513 is the center 2711 of the preview screen image 2721, in the captured image 251 stored in the memory 260.

As illustrated in FIG. 8, in one embodiment, the display control program instruction set 270 crops the captured image 251 so that the position of the laser point 212 is the center 2711 of the preview screen image 2721 output on the display 280. Accordingly, the preview screen image 2721 of a lower resolution compared to the captured image 251 is generated. For example, the full resolution of the captured image 251 may be a resolution of 13.13 MP (4208×3120) pixels, while the resolution of the cropped display image 2721 may be a resolution of 7.5 MP (3360×2240) pixels. In inverse proportion to the assembly error, that is, in inverse proportion to the degree of separation between the position of the laser point 212 and the position of the center 2511 of the captured image 251, the resolution of the preview screen image 2721 may become lower. In the embodiment, the preview screen image 2721 according to the present invention may be generated to have a lower resolution than the resolution of a preview screen image in the related art.

In the embodiment, the resolution of the preview screen image 2721 may be lowered in inverse proportion to the degree of separation from the center of the captured image 251, while an aspect ratio of the preview screen image 2721 may be constant. For example, when the aspect ratio of the display 280 is 4:3, the aspect ratio of the preview screen image may also be 4:3.

### [Description of Claim 13]

FIG. 5 is a block diagram illustrating a configuration of the display controller 270. Hereinafter, the display controller 270 will be described with reference to FIG. 5.

According to a characteristic aspect of the present invention, the display control program instruction set 270 may include a preview screen image center position calculation program instruction set 271 for calculating the position of the center 2711 of the preview screen image 2721 in the captured image 251 using the X-axis direction calibration value 2512 and the Y-axis direction calibration value 2513, a crop program instruction set 272 for determining a resolution of the preview screen image 2721 based on the position of the center 2711 of the preview screen image 2721 in the captured image 251 and generating the preview screen image 2721 by cropping the captured image 251, and an overlay program instruction set 273 for superimposing information of the distance to the target 2514 on the preview screen image 2721.

The display control program instruction set 270 may read a logically set display region (not illustrated) inside the memory 260 where the captured image 251 is stored and control the display image 2721 to be output on the display 280.

The non-volatile memory 290 stores the X-axis direction calibration value 2512 and the Y-axis direction calibration value 2513. The X-axis direction calibration value 2512 and the Y-axis direction calibration value 2513 may be transmitted from the screen calibration apparatus 10 through the interface 211 included in the laser range finder 20.

The preview screen image center position calculation program instruction set 271 may calculate the position of the center 2711 of the display image 2721 in the captured image 251 using the X-axis direction calibration value 2512 and the Y-axis direction calibration value 2513.

The crop program instruction set 272 determines the resolution of the preview screen image 2721 based on the position of the center 2711 of the display image 2721 in the captured image 251 and generates the preview screen image 2721 by cropping the captured image 251.

In the embodiment, the crop program instruction set 272 determines the resolution of the preview screen image 2721 based on the position of the center 2711 of the preview screen image 2721 within the captured image 251. As the assembly error is greater, that is, the position of the center 2711 of the preview screen image 2721 is closer to an edge of the region of the captured image 251, the crop program instruction set 272 determines that the resolution of the preview screen image 2721 is lower. Typically, the resolution of the cropped preview screen image may use 60% to 80% of the resolution of the entire captured image within the camera optical system. In the present invention, for example, up to 50% of the full resolution of the captured image may be set as the minimum resolution of the preview screen image. Accordingly, according to an advantageous aspect of the present invention, it is possible to provide the preview screen image 2721 with as high a resolution as possible with respect to the assembly error.

The overlay program instruction set 273 included in the display control program instruction set 270 superimposes information on the distance to the target 2514 calculated from the distance calculation program instruction set 230 on the cropped preview screen image 2721.

According to the present invention, the X-axis direction calibration value 2512 and the Y-axis direction calibration value 2513 between the position of the center 2511 of the captured image and the position of the laser point 212 due to the assembly error are calculated in the captured image, the center 2711 of the preview screen image 2721 in the captured image 251 is calculated in the captured image 251 using the X-axis direction calibration value 2512 and the Y-axis direction calibration value 2513 so that the laser point is positioned at the center of the display image output on the display 280 of the laser range finder 20, and the preview screen image 2721 is generated by cropping the captured image 251. Accordingly, even when an assembly error occurs, the laser point 212 may be accurately aimed at the target 2514.

According to the suggested invention, a laser point can be accurately aimed at a target even when an assembly error occurs between a laser component and a camera optical system component included in a laser range finder.

Further, according to the suggested invention, the production process rate can be increased by calibrating an assembly error occurring between a laser component and a camera optical system component included in a laser range finder using software, thereby maximizing cost reduction and quality product production.

In the case of a laser range finder in the related art, the center of a preview screen image corresponds to the center of a camera optical system. Accordingly, when there is an assembly error in the laser range finder, the position of a laser point and the position of the center of a preview screen image are different, making target aiming difficult or impossible. However, according to preferred aspects of the present invention, the user can aim at a target based on the position of the laser point rather than the position of the center of the captured image, so that even when an assembly error occurs, the laser point can be accurately aimed at the target.

In the above, the present invention has been described through embodiments with reference to the attached drawings, but it is not limited thereto, and should be interpreted to encompass various modifications that can be easily derived by those skilled in the art. The claims are intended to cover the modifications.

1. A calibration apparatus of a camera-based laser range finder, comprising:
a test jig equipped with the laser range finder that is a device under test (DUT);
a calibration chart fixing member positioned at a certain distance in front of the test jig; and
a calibration controller including an interface connected to the laser range finder, a storage for storing a program, and a processor for executing the program,
wherein the program executed by the processor includes a calibration value computation program instruction set for providing information on a preview screen region extracted from a captured image output from an image sensor of the laser range finder and calculating and outputting an X-axis direction calibration value and a Y-axis direction calibration value required for a laser point to be positioned at a center of a preview screen.

2. The calibration apparatus of claim 1, wherein the calibration value computation program instruction set includes:
a device under test driving program instruction set for driving the laser range finder;
a laser point recognition program instruction set for recognizing the laser point in the captured image received from the laser range finder;
a laser point position calculation program instruction set for calculating a position of the laser point in the captured image;
a calibration value calculation program instruction set for calculating an X-axis direction calibration value and a Y-axis direction calibration value required for the laser point to be positioned at a center of a calibration chart in the captured image; and
a calibration value output program instruction set for outputting the X-axis direction calibration value and the Y-axis direction calibration value.

3. The calibration apparatus of claim 2, wherein the calibration value output program instruction set stores the X-axis direction calibration value and the Y-axis direction calibration value in a non-volatile memory included in the laser range finder through the interface.

4. The calibration apparatus of claim 3, wherein as the test jig is rotated in a yaw direction and a pitch direction, the calibration value calculation program instruction set calculates the X-axis direction calibration value that is a distance moved by the laser point in an X-axis direction in the captured image in response to the rotation in the yaw direction and the Y-axis direction calibration value that is a distance moved by the laser point in a Y-axis direction in the captured image in response to the rotation in the pitch direction.

5. The calibration apparatus of claim 3, wherein the calibration value computation program instruction set further includes a calibration possibility determination program instruction set for determining whether calibration is possible by comparing a maximum X-axis direction calibration threshold and a maximum Y-axis direction calibration threshold that are maximally calibratable in consideration of a resolution of a captured image corresponding to a field of view of a camera optical system of the laser range finder and a minimum resolution of a preview screen image output on a display of the laser range finder with the X-axis direction calibration value and the Y-axis direction calibration value.

6. A screen calibration method of a calibration apparatus of a camera-based laser range finder including a test jig equipped with the laser range finder that is a device under test (DUT), a calibration chart fixing member positioned at a certain distance in front of the test jig, and a calibration controller including an interface connected to the laser range finder, a storage for storing a program, and a processor for executing the program, the screen calibration method comprising:
a receiving operation of receiving a captured image output from an image sensor of the laser range finder; and
a calibration value computing operation of providing information on a preview screen region extracted from the captured image and calculating and outputting an X-axis direction calibration value and a Y-axis direction calibration value required for a laser point to be positioned at a center of a preview screen.

7. The screen calibration method of claim 6, wherein the calibration value computing operation includes:
a device under test driving operation of driving the laser range finder;
a laser point recognizing operation of recognizing the laser point in the captured image received from the laser range finder;
a laser point position calculating operation of calculating a position of the laser point in the captured image;
a calibration value calculating operation of calculating an X-axis direction calibration value and a Y-axis direction calibration value required for the laser point to be positioned at a center of a calibration chart in the captured image; and
a calibration value outputting operation of outputting the X-axis direction calibration value and the Y-axis direction calibration value.

8. The screen calibration method of claim 7, wherein in the calibration value outputting operation, the X-axis direction calibration value and the Y-axis direction calibration value are stored in a non-volatile memory included in the laser range finder through the interface.

9. The screen calibration method of claim 8, wherein in the calibration value calculating operation, as the test jig is rotated in a yaw direction and a pitch direction, the X-axis direction calibration value that is a distance moved by the laser point in an X-axis direction in the captured image in response to the rotation in the yaw direction and the Y-axis direction calibration value that is a distance moved by the laser point in a Y-axis direction in the captured image in response to the rotation in the pitch direction are calculated.

10. The screen calibration method of claim 8, wherein the calibration value computing operation further includes a calibration possibility determining operation of determining whether calibration is possible by comparing a maximum X-axis direction calibration threshold and a maximum Y-axis direction calibration threshold that are maximally calibratable in consideration of a resolution of a captured image corresponding to a field of view of a camera optical system of the laser range finder and a minimum resolution of a preview screen image output on a display of the laser range finder with the X-axis direction calibration value and the Y-axis direction calibration value.

11. A screen calibration apparatus of a camera-based laser range finder, the camera-based laser range finder comprising:
a laser transmitter configured to emit a laser;
a laser receiver configured to receive a reflected wave being reflected from a target hit by the emitted laser;
a camera optical system configured to receive incident light within a field of view of the camera optical system;
an image sensor configured to convert the incident light and to output a captured image;
a memory configured to store the captured image;
a display configured to output a preview screen image; and
a processor configured to execute a program stored in a storage,
wherein the program executed by the processor includes:
a distance calculation program instruction set for calculating a distance to the target based on the received reflected wave; and
a display control program instruction set for generating a preview screen image that displays information of the calculated distance to the target by superimposing the information on at least a portion of the captured image stored in the memory,
the camera-based laser range finder further comprises a non-volatile memory configured to store an X-axis direction calibration value and a Y-axis direction calibration value to calibrate a difference between a position of a center of the captured image and a position of a laser point due to an assembly error, and
the display control program instruction set performs control to extract a preview screen region in which a position moved from the position of the center of the captured image according to the X-axis direction calibration value and the Y-axis direction calibration value is set as a center of the preview screen region from the captured image stored in the memory and to output the preview screen region on the display.

12. The screen calibration apparatus of claim 11, wherein the display control program instruction set generates a preview screen image of a lower resolution compared to the captured image by cropping the captured image so that a position moved from the position of the center of the captured image according to the X-axis direction calibration value and the Y-axis direction calibration value is the center of the preview screen image, in the captured image stored in the memory.

13. The screen calibration apparatus of claim 12, wherein the display control program instruction set includes:
a preview screen image center position calculation program instruction set for calculating the position of the center of the preview screen image in the captured image using the X-axis direction calibration value and the Y-axis direction calibration value;
a crop program instruction set for determining a resolution of the preview screen image based on the position of the center of the preview screen image in the captured image and generating the preview screen image by cropping the captured image; and
an overlay program instruction set for superimposing the information of the distance to the target on the preview screen image.
